(19) United States
(12) Patent Application Publication
(10) Pub. No.: US 2007/0182044 A1
(43) Pub. Date: Aug. 9, 2007

(54) METHOD FOR OPERATING AN INJECTION MOLDING MACHINE

(75) Inventor: GUNTHER GRIMM, Hilgertshausen (DE)

Correspondence Address: Henry M. Feiereisen;Henry M. Feiereisen, LLC, Suite 4714, 350 Fifth Avenue, New York, NY, 10118, US

(73) Assignee: Krauss-Maffei Kunststofftechnik GmbH, Munchen (DE)

(21) Appl. No.: 11/733,931

(22) Filed: Apr. 11, 2007

Related U.S. Application Data
(63) Continuation of application No. PCT/EP05/55075, filed on Oct. 6, 2005.

(30) Foreign Application Priority Data
Oct. 16, 2004 (DE) 10 2004 050 445.8

(51) Int. Cl. B29C 45/76

(52) U.S. Cl. 264/39; 264/40.1

(57) ABSTRACT

In a method for operating an injection molding machine, particularly a method for securing tools of an injection molding machine, a desired variable curve is determined along at least one section of a travel path of a molding tool in a desired variable determination phase, and the injection molding machine is operated according to the determined desired variable curve in a subsequent operational phase. A default curve of at least one initial variable is predefined, the molding tool is driven in accordance with the default curve of the initial variable in a test run, at least one resulting value of the desired variable is measured and stored during the test run, and a desired variable curve is formed along the section of the travel path from the measured values of the desired variable.

### CROSS-REFERENCES TO RELATED APPLICATIONS

This application is a continuation of prior filed copending PCT International application no. PCT/EP2005/055075, filed Oct. 6, 2005, which designated the United States and has been published but not in English as International Publication No. WO 2006/040298 and on which priority is claimed under 35 U.S.C. §120, and which claims the priority of German Patent Application, Serial No. 10 2004 050 445.8, filed Oct. 16, 2004, pursuant to 35 U.S.C. 119(a)-(d), the contents of which are incorporated herein by reference in its entirety as if fully set forth herein.

### BACKGROUND OF THE INVENTION

The present invention relates, in general, to a method for operating an injection molding machine, and more particularly to a method by which a desired variable curve is determined for securing a molding tool of an injection molding machine, and the injection molding machine is operated based on the determined desired variable curve.

Nothing in the following discussion of the state of the art is to be construed as an admission of prior art.

Heretofore, a desired force curve is established for the closing force of a molding tool, e.g., the mold of an injection molding machine, by defining a single or multi-step pressure profile during the determination phase of a desired force at the end of the closing process of a molding tool of the injection molding machine. This pressure profile is determined manually and empirically, i.e., the operator of the injection molding machine iteratively decreases the driving force for a moved half-mold along an end segment of the mold closing phase until the driving force is ideally only capable of overcoming the friction losses in the bearing of a moved half-mold. From this empirically and manually determined minimum operating force, a desired force curve is determined, optionally by adding an offset value, for the end segment of the mold closing phase. If the determined desired force curve is applied to the injection molding machine in an operating phase of a manufacturing process, the result is a travel time required by the moved half-mold for the travel path, i.e., the mold closing phase. In the operating phase of the injection molding machine, this travel time is measured during operation for each closing operation of the mold as an actual value and compared with the desired travel time. If a malfunction prevents the mold from closing, for example due to the presence of a foreign object between the half-molds or the like, the previously set desired closing force is no longer sufficient to completely close the molding tool within the preset closing time. After the desired closing time has been exceeded, it will be assumed that an obstruction is present, and the drive of the molding tool is switched off. This prevents damage to the molding tool and/or to a molded part which may inadvertently be still present between the half-molds. This method has proven successful, but is complex and labor-intensive for the phase of determining the desired force curve, because the minimum travel force must be approached interactively and manually. This requires long adjustment times and the operator must have considerable experience in the initial selection of the force level used to start the determination. This requires considerable training. The injection molding machine also requires a costly setup, for example after a tool change.

It is also disadvantageous that the speed and travel path curves along the mold closing motion affect the required travel forces, so that the desired closing force must be newly determined, when these parameters are changed, which also is complicated. If this is not done, errors in the molding tool safety can occur. The methods according to the present state of art are time-consuming and error-prone. It is also disadvantageous that a change in the speed and/or travel path curves of the mold closing process directly affects the desired travel time, so that, for example, a change in the desired cycle time requires a new manual, empirical determination of the tool safety time, i.e., the desired travel time. If this is not done, errors in the molding tool safety can occur, which is undesirable.

It would therefore be desirable and advantageous to provide an improved method for operating a machine tool, in particular an injection molding machine, to obviate prior art shortcomings and to minimize and/or automate the complexity of determining a desired variable curve for the operating phase of the injection molding machine as well as to reduce a required training and education of the operating personnel and to minimize the time between a tool change and restart of an injection molding machine with a desired variable curve adapted to the new molding tool.

### SUMMARY OF THE INVENTION

According to one aspect of the present invention, a method for operating an injection molding machine, in particular a method for securing a mold tool of an injection molding machine, includes the steps of determining, in a determination phase, a desired variable along at least one segment of a travel path of a mold tool, said desired variable defining a desired variable curve, defining a default curve of at least one initial variable, by driving the mold tool in a test run corresponding to the default curve of the at least one initial variable, measuring during the test run at least one resulting variable of the desired variable and storing the at least one resulting variable, and computing from the measured values of the desired variable the desired variable curve along the at least one travel path segment; and operating, in a subsequent operating phase, the injection molding machine in accordance with the computed desired variable curve.

The present invention resolves prior art problems by dividing the method according to the invention for operating an injection molding machine into a determination phase for a desired variable, in which a desired variable curve along at least a segment of a tool travel path of a molding tool is determined, and into an operating phase, in which the injection molding machine is operated according to the determined desired variable curve. Determination of the desired variable in the determination phase for the desired variable includes the steps of presetting at least one initial variable for operating the molding tool, a test run whereby the mold is driven in accordance with the default curve of the initial variable, a measurement and storage process of at least one resulting value of the desired variable, which is preferably different from the initial variable, during the test run, and formation of a desired variable curve along a travel path segment from the measured values of the desired variable.

It is particularly advantageous with this method, that an easily selectable curve of the initial variable corresponding to a desired closing motion of the molding tool can be preset, and the desired variable curve required for driving the injection molding machine in the operating phase can be automatically determined by the controller of the machine itself. This obviates the need for a complicated iterative manual setup or adjustment of the driving forces of the injection molding machine for each travel path segment. A suitable proven initial variable is, for example, a speed profile along the opening and/or closing path. This speed profile depends essentially on the desired cycle time. For example, if an increase in the cycle time is possible or desired due to a constructive change of the molding tool, then a speed of the speed profile is increased in certain segments. Such a change, in conjunction with an automatic test run and a subsequent automatic determination of the desired variable curve, can then form the basis for the further operation of the injection molding machine within a very short time.

It is also advantageous, that the travel path segment is at least a partial segment of the opening and/or closing motion of a mold of the injection molding machine. This feature of the process is advantageous in particular when, for example, an idle stroke is performed at the beginning of a molding tool motion. This idle stroke must not necessarily be traveled along a desired variable curve, but can also be traveled with a maximum force that is only limited by the drive unit of the machine.

It is particularly advantageous, however, to establish the travel path segment based on the entire opening and/or closing motion of the molding tool, because it may be necessary with modern, rather complicated tools to monitor the entire molding tool motion.

To prevent false alarms of an alarm system, it may be advantageous to add to or subtract from the automatically desired variable curve a tolerance value.

Suitable desired variable curves are, for example, the closing force and/or the opening force curve, as well as a time dependence of the movement of the molding tool.

It is also advantageous that the measured values of the desired variables are associated with path points or path parameters of the travel path segment of the molding tool. This enables an exact representation of the predetermined speed profile in accordance with the operators intent.

During the operating phase, the drive of the machine tool is operated according to the formed desired variable curve. A time measurement with respect to the travel path segments is performed during each stroke of the molding tool. The so determined actual time values are compared with the desired travel time for the corresponding travel path segment. If the actual travel time exceeds or falls below the desired travel time, or optionally if the actual travel time exceeds or falls below the desired travel time plus and/or minus a tolerance band, it will be assumed that the injection molding machine malfunctions. The drive is then switched off, and optionally an alarm is triggered.

For increasing the accuracy, it is particularly advantageous to subdivide the travel path segments into sub-segments using a raster. A corresponding time sub-segment is determined and stored for each sub-segment.

The travel path segments can also be characteristic segments of the default curve for the initial parameters, for example segments having a constant travel speed.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 an exemplary default curve of a desired/actual speed profile of a half-mold of a molding tool moved along the mold travel path;

FIG. 2 a flow diagram depicting the process steps during a phase for determining the desired variables according to the method of the invention; and

FIG. 3 a flow diagram depicting the process steps in the operating phase of the method according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

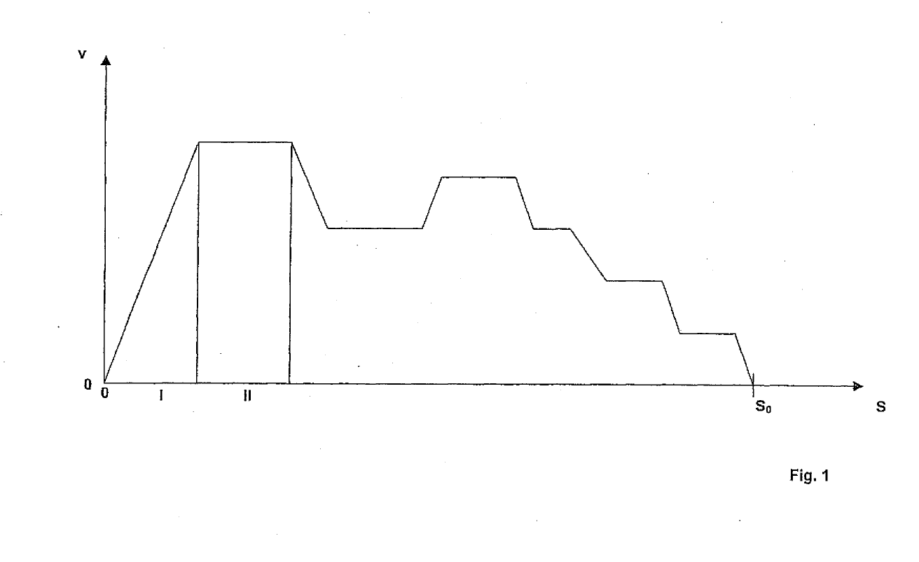

Turning now to the drawing, and in particular to FIG. 1, there is shown an exemplary default curve of an initial variable, based on which a desired variable curve for triggering a tool safety of a molding tool of an injection molding machine is automatically determined in accordance with the method of the invention, FIG. 1 shows a curve of the speed of a moved half-mold as a function of its closing motion or travel path from 0 to S₀. In a zone I, the preset speed and hence also the initial variable v increases to an initial speed. In a zone II, the half-mold moves at a constant speed with this initial speed. In additional zones, the default curve of the initial variable v follows a stepped profile with braking and acceleration phases and with phases having a constant speed. At the end of the travel path, when the mold closes, the travel speed of the molding tool is, of course, zero. The curve of such a speed profile with different speeds v along the travel path from 0 to S₀ can be easily foreseen or predicted, because travel can occur without problem at maximum speed in those segments where, for example, an idle stroke occurs, whereas lower speeds are desired in those segments where, for example, sliding gates are to be engaged and carried along. An operator of an injection molding machine can easily, without considerable training, determine and preset a suitable speed profile as an initial variable curve, i.e., the default curve of an initial variable.

This speed curve, i.e., the default curve of the initial variable v along the travel path of the half-mold, can be readily run by a machine controller, as long as the machine has speed sensors or similar devices for determining the speed of a half-mold. This obviates the need for the operator to determine complex driving forces required for implementing the speed profile manually. As opposed to the state of art, the driving force which is barely sufficient to overcome friction losses is also no longer significant, and the forces which are required depending on the preset speed profile, in particular during the acceleration and braking phases, are determined automatically. These forces are limited only by the maximum force that a drive unit of the injection molding machine can produce.

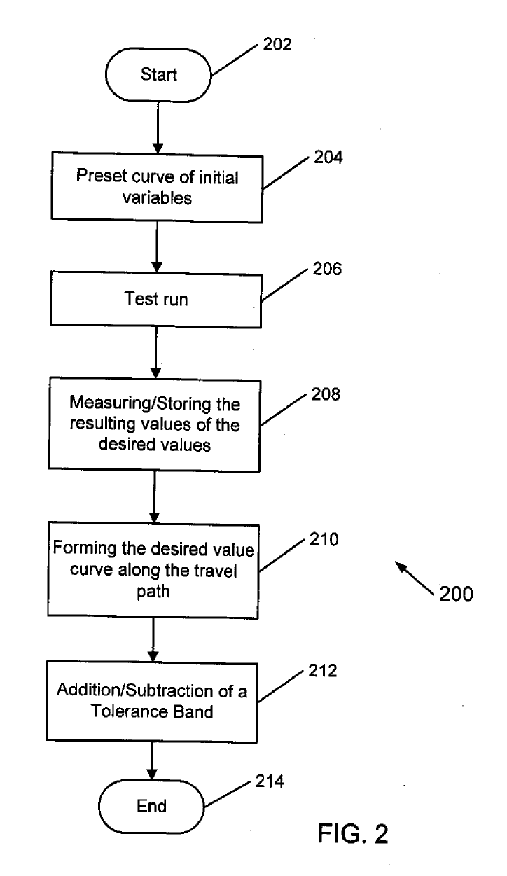

FIG. 2 shows a process 200 in a determination phase for a desired variable in accordance with the method of the invention.

The process 200 starts at step 202. At step 204, a default speed curve is preset by the operator, as described with reference to FIG. 1, for determining a desired variable to be used for operating an injection molding machine according to the invention. After conclusion step 204, the preset speed profile is traveled in a test run of the injection molding machine, including the molding tool, once in the closure direction and/or in the opening direction, at step 204. During the test run, the driving force for moving the half-mold is limited only by the rated power of the drive unit of the injection molding machine. During the test run, resulting values of the desired variable, which are different from the initial variable, are measured continuously or cyclically, and these values are stored as desired variable, at step 208. Suitable desired variables, e.g., the driving force required for a certain travel path segment along the speed profile, is measured, for example, by a pressure sensor in the hydraulic drive system of the injection molding machine.

Another suitable variable whose values can be measured during a test run, is for example the travel path of the molding tool, wherein the respective position associated with a characteristic region or point of the preset speed curve (of the initial parameter curve) is determined by using path sensors arranged along the travel path. The determined values of the desired variable are stored in conventional storage media.

In a subsequent process step 210, a desired variable curve is formed, e.g., computed, from the measured and stored values of the, preferably numerous, desired variables along the travel path segment and/or the entire travel path of the half-mold.

This process step generates as outcome a desired variable curve along a travel path segment and/or along the entire travel path, which forms the basis for an operating phase of the injection molding machine. This desired variable curve is determined by the method according to the invention in a single test run without iterative approximation steps, solely based on a default curve of an initial variable which can be easily determined and easily entered.

It is particularly advantageous, shown as step 212 in process 200, to superimpose on the automatically determined desired variable curve along a travel path segment an additional tolerance band, so that a tolerated desired variable curve is established which forms the basis for the subsequent operation of the injection molding machine. The width of the tolerance band can have different tolerances along the travel path; for example, the tolerances can be selected to be somewhat larger during acceleration and/or braking phases of the molding tool than in the region of constant travel speed, because malfunctions of the operating forces can occur to a greater degree during acceleration and/or braking phases. The process 200 ends at step 214.

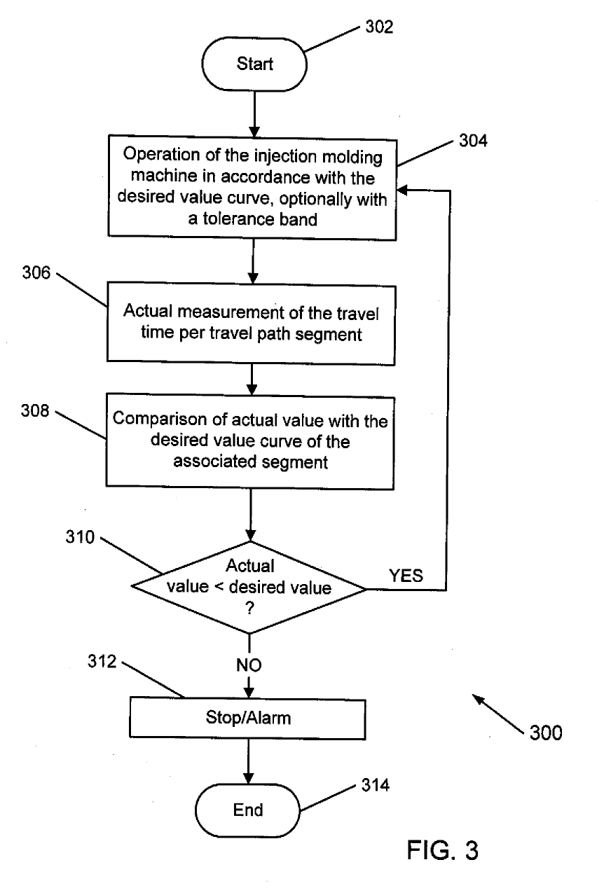

FIG. 3 shows a process 300 for operating an injection molding machine in accordance with the desired variable curve determined by process 200.

Process 300 starts at step 302. Based on the desired variable curve determined in the determination phase for the desired variables, which can optionally be provided with a tolerance band, the injection molding machine is now operated in an operating phase, at step 304. An actual value of the travel time or the instantaneous driving force for each travel path segment is measured during each production cycle of the injection molding machine, at step 306. When the desired variable curve is a force curve, the actual force is, of course, measured during the operation of the injection molding machine. When the desired curve is a travel path curve, it is recommended to measure the travel path as an actual value during the operation of the injection molding machine.

The measured actual values are compared with the desired variable curve for the corresponding profile segment stored in the injection molding machine, at step 308. At step 310, process 300 determines if the actual value measured during operation is within the tolerance band or below the desired variable curve. If the measured actual value is within the tolerance band or below the desired variable curve in an uncritical segment, the operation of the injection molding machine is continued, and process 300 goes to step 304. Conversely, if the measured actual value is outside the tolerance band or if the measured actual value is greater or smaller than the corresponding value of the desired variable curve at this location of the profile, then this is interpreted as a machine malfunction, and the drive of the machine is switched off to prevent damage to the molding tool, as indicated at step 312. Optionally, in addition to stopping the machine, an alarm can be displayed in acoustic or visual form. Process 300 ends at step 314.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating an injection molding machine, in particular a method for securing a mold tool of an injection molding machine, comprising the steps of:
determining, in a determination phase, a desired variable along at least one segment of a travel path of a mold tool, with the desired variable defining a desired variable curve, by
defining a default curve of at least one initial variable,
driving the mold tool in a test run corresponding to the default curve of the at least one initial variable,
measuring during the test run at least one resulting variable of the desired variable and storing the at least one resulting variable, and
computing from the measured values of the desired variable the desired variable curve along the at least one travel path segment; and
operating, in a subsequent operating phase, the injection molding machine in accordance with the computed desired variable curve.

2. The method of claim 1, wherein the desired variable is a variable different from the at least one initial variable.

3. The method of claim 1, wherein the initial variable is a speed of a speed profile along the travel path segment.

4. The method of claim 1, wherein the at least one travel path segment is at least a partial segment of an opening or closing motion, or both, of the mold tool of the injection molding machine.

5. The method of claim 1, wherein the at least one travel path segment includes an entire opening or closing motion, or both, of the mold.

6. The method of claim 1, wherein a tolerance variable is added to or subtracted from the desired variable curve.

7. The method of claim 1, wherein the desired variable curve is a closing force or an opening force curve, or both.

8. The method of claim 1, wherein the desired variable curve is a time dependence of a mold motion.

9. The method of claim 1, wherein the default curve of the at least one initial variable is preset depending on a desired cycle time.

10. The method of claim 1, wherein during the test run, the injection molding machine is operated without limiting a driving force for driving the mold tool.

11. The method of claim 10, wherein the driving force is a maximum driving force of the injection molding machine

12. The method of claim 1, wherein common values are associated with desired variable path points and/or path parameters of the travel path segment of the mold.

13. The method of claim 1, wherein in the operating phase, the machine tools is driven in accordance to the desired variable curve.

14. The method of claim 1, further comprising the steps of in the operating phase, performing a time measurement along the at least one travel path segment to determine an actual travel time, and comparing the actual travel time with a desired travel time along the corresponding travel path segment.

15. The method of claim 14, and further comprising the step of switching the drive of the machine tool off, when the actual travel time exceeds or falls below the desired travel time, or when the actual travel time exceeds the desired travel time plus a tolerance time or falls below the desired travel time minus a tolerance time.

16. The method of claim 14, and further comprising the step of triggering an alarm or a malfunction indication when the drive of the machine tool is switched off.

17. The method of claim 14, and further comprising the step of determining a travel time segment for a corresponding travel path segment, and storing the travel time segment.

18. The method of claim 1, wherein a travel path segment corresponds to a characteristic segment of the default curve of the at least one initial variable.

19. The method of claim 15, and further comprising the steps of subdividing a travel path segment with a raster into a plurality of sub-segments, determining a travel time sub-segment for a corresponding travel path sub-segment, and storing the travel time sub-segment.
